(19) United States
(12) Patent Application Publication
(10) Pub. No.: US 2012/0194500 A1
(43) Pub. Date: Aug. 2, 2012

(54) PIXEL DRIVER WITH COMMON ELEMENT STRUCTURE

(76) Inventors: Yuh-Ren YEN, Tainan City (TW); Kai-Lan Chuang, Tainan City (TW)

(21) Appl. No.: 13/343,943

(22) Filed: Jan. 5, 2012

(30) Foreign Application Priority Data
Feb. 1, 2011 (TW) 100103844

(51) Int. Cl. G09G 5/00

(52) U.S. Cl. 345/212

(57) ABSTRACT

A pixel driver includes an image signal module, a data latch module, a level shifter module, and a format conversion module, wherein the format conversion module includes at least one first conversion unit and a second conversion unit. The data latch module stores the digital signal generated by the image signal module temporarily and then transmits the digital signal to the level shifter module. The level shifter module increases the voltage of the digital signal and then transmits the digital signal to the format conversion module, wherein the conversion units generate analogue signals based on the digital signal received to drive different pixel units.

### BACKGROUND OF THE INVENTION

1. Field of the Invention

This invention relates to a pixel driver; specifically to a pixel driver with common electronic component structure for various applications.

2. Description of the Prior Art

The planar display such as liquid crystal displays or light emitting diode displays all include a plurality of pixel units, wherein each display has a driving integrated circuit for driving the pixel units. For instance, the driving integrated circuit of the liquid crystal displays will generate a plurality of analogue voltages to be transmitted to a storage capacitor and a liquid crystal capacitor of each pixel unit, in order to adjust the twist of the liquid crystal molecules within each pixel unit.

In the pixel unit driver technology, each voltage output terminal of a conventional driving integrated circuit is connected to one of the pixel units. Furthermore, the conventional driving integrated circuit will generate driving voltages corresponding to each pixel unit and then transmit those voltages to the corresponding pixel units through the voltage output terminals. However, the number of electronic components used in the conventional driving integrated circuit for processing driving voltages is directly proportional to the number of pixel units in the display. As the resolution of displays increases, the number of pixel units to be driven by the conventional driving integrated circuit also increases. Thus, the number of electronic components used in the conventional driving integrated circuit needs to increase together with the resolution of the displays. In this way, the size and the costs of the conventional driving integrated circuit will also increase as the resolution of the display increases. This shows that there is still room for reducing the number of electronic components used in the driving integrated circuit for processing driving voltages and the size of the driving integrated circuit.

### SUMMARY OF THE INVENTION

It is an objective of the present invention to provide a pixel driver with common electronic component structure which uses less electronic components and has less volume, wherein many electronic components are commonly shared for various applications.

It is another objective of the present invention to provide a pixel driver having different output terminals outputting the same driving signals.

The pixel driver of the present invention includes an image signal module, a data latch module, a level shifter module, a format conversion module, and a buffer amplifier module. The image signal module generates digital signals to be temporally stored in the data latch module. The level shifter module receives digital signals from the data latch module and then increases the voltage of the digital signal. The format conversion module receives the digital signal from the level shifter module and generates a corresponding analogue signal which is then amplified by the buffer amplifier module, wherein the amplified analogue signal is then transmitted to the pixel unit of a display panel.

In preferred embodiment, the level shifter module includes at least a first level shifter and a second level shifter for receiving digital signals from the data latch module respectively. The format conversion module includes at least a first conversion unit and a second conversion unit connected to the first level shifter and the second level shifter respectively to receive digital signals. The first conversion unit and the second conversion unit convert the digital signals to corresponding analogue signals for driving the pixel units of the display panel. The digital signals received by the first level shifter and the second level shifter are substantially the same and therefore the analogue signals generated by the first conversion unit and the second conversion unit are substantially the same.

In different embodiments, the first conversion unit and the second conversion unit are connected to the same level shifter to receive the same digital signal. In this way, the analogue signals generated by the first conversion unit and the second conversion unit are substantially the same. In other words, the image data received by the pixel units corresponding to the first conversion unit and the second conversion unit are substantially the same and therefore both pixel units produce images that are substantially the same.

### BRIEF DESCRIPTION OF THE DRAWINGS

FIG. 1 is a block diagram of the planar display in one embodiment of the present invention;

FIG. 2 is a block diagram of the pixel driver of the present invention;

FIG. 3 illustrates another embodiment of the pixel driver of the present invention; and

FIG. 4 is a variation of the pixel driver illustrated in FIG. 3.

### DETAILED DESCRIPTION OF THE PREFERRED EMBODIMENT

The present invention discloses a pixel driver and specifically a pixel driver having common electronic component structure for various applications. The pixel driver of the present invention is preferably used to drive pixel units in the liquid crystal displays, but is not limited thereto; in different embodiments, the pixel driver of the present invention having common electronic component structure for various applications can be used in other types of planar displays.

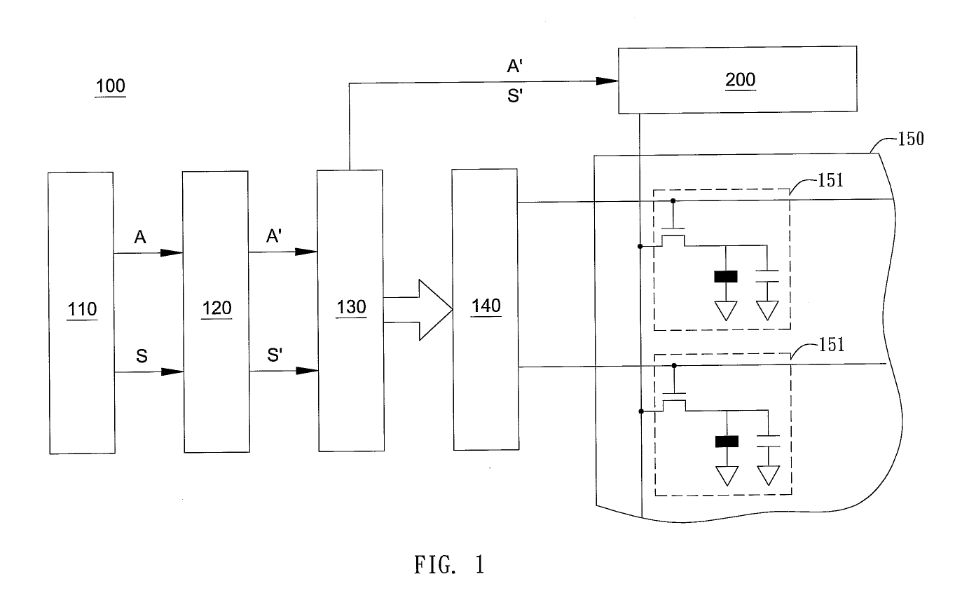

FIG. 1 is a block diagram of the planar display 100 in one embodiment of the present invention. The planar display 100 of the present embodiment includes an image controller 110, an analogue-to-digital converter 120, a timing controller 130, a gate driver module 140, a display panel 150, and a pixel driver 200. As FIG. 1 shows, the image controller 110 transmits analogue signals such as an analogue color field signal A and an analogue synchronization signal S to the analogue-to-digital converter 120 to be converted to a digital color field signal A′ and a digital sequence signal S′. The analogue synchronization signal S includes conventional horizontal synchronization signals (HSYNC) and vertical synchronization signals (VSYNC) used for informing the timing controller 130 the timing to drive the display panel 150 and therefore is not further elaborated here. The analogue-to-digital converter 120 then generates digital signals, e.g. the digital color field signal A′ and the digital sequence signal S′, based on analogue signals mentioned above and transmits those digital signals to the timing controller 130.

In the embodiment illustrated in FIG. 1, the display panel 150 is a liquid crystal display panel having a plurality of pixel units 151, wherein each of the pixel units 151 includes a thin-film transistor, a storage capacitor, and a liquid crystal capacitor. The timing controller 130 uses the digital sequence signal S′ as a reference for commanding the gate driver module 140 to send voltages to the gates of the thin-film transistors within different pixel units 151 at different time intervals, so that current can flow through the source and gate of the thin-film transistor and toward the storage capacitor and the liquid crystal capacitor. In other words, the gate of the thin-film transistor is a switch used to control the current flow in the pixel unit 151.

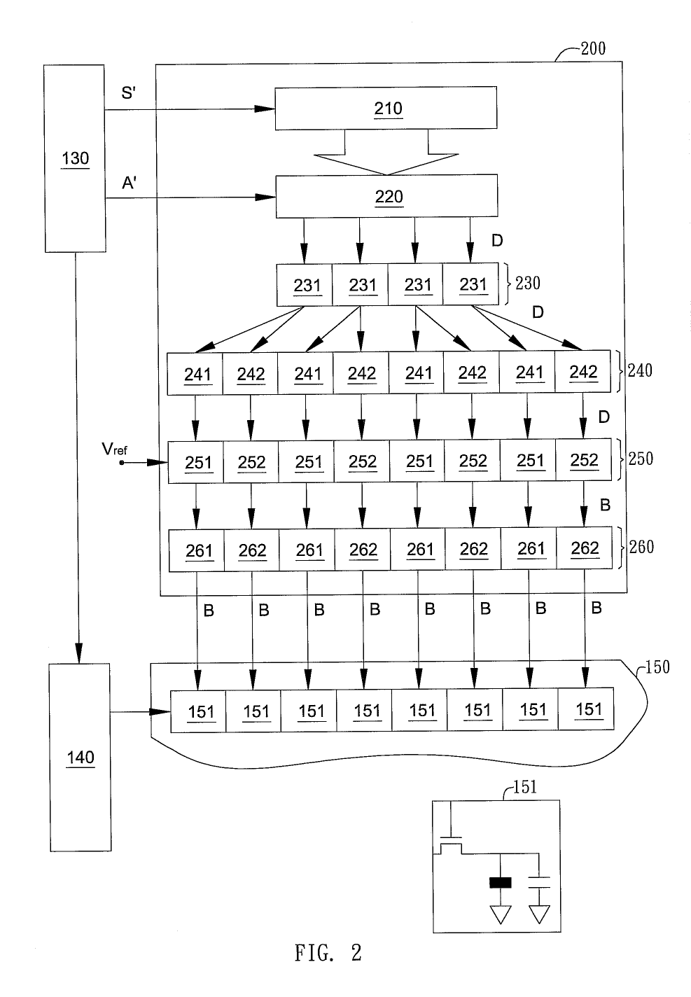

In the embodiment illustrated in FIG. 1, after the timing controller 130 inputs voltages into the gate of the transistor in the pixel unit 151, the timing controller 130 will then control the pixel driver 200 of the present invention to output voltage to the source of the thin-film transistors in order to charge or discharge the storage capacitor and the liquid crystal capacitor via the source and the gate of the thin-film transistor and update the voltages of those capacitors. In this way, the timing controller 130 illustrated in FIG. 2 uses the gate driver module 140 and the pixel driver 200 to control the twist of the liquid crystal molecules in the pixel unit 151 and also the output brightness of the display panel 150.

FIG. 2 is a block diagram of the pixel driver 200 of the present invention. The pixel driver 200 includes a timing controller module 210, an image signal module 220, a data latch module 230, a level shifter module 240, a format conversion module 250, and a buffer amplifier module 260. In the present embodiment, the timing controller module 210 and the image signal module 220 are connected to the timing controller 130 illustrated in FIG. 1 to accept the digital sequence signal S′ and the digital color field signal A′, respectively. The timing controller module 210 uses the digital sequence signal S′ as a reference to control the image signal module 220 to transmit digital driving signals D to the data latch module 230 via interfaces such as data buses.

As FIG. 2 shows, the data latch module 230 includes a plurality of data latch units 231 receiving digital driving signals D from the image signal module 220 respectively and storing those data contained in the digital driving signals D temporally. Furthermore, the data latch units 231 of the present embodiment are preferably SR latches, but are not limited thereto; in different embodiments, the data latch units 231 also include data storages such as gated D latches, flip-flops such as edge triggered flip-flops, and other buffers for storing one bit of data.

In the embodiment illustrated in FIG. 2, the digital driving signals D will be converted to analogue driving signals B and then transmitted to the storage capacitors and the liquid crystal capacitors in the pixel units 151 of the display panel 150. However, the power of the digital driving signal D may not be enough to drive the buffer amplifier module 260 of the pixel driver 200 and other transistors. Therefore, the level shifter module 240 is used to increase the voltage and the power of the digital driving signal D to a suitable level in order to drive the buffer amplifier module 260 and other transistors.

The level shifter module 240 of the present embodiment includes a plurality of first level shifters 241 and a plurality of second level shifters 242 alternatively arranged. One of the first level shifters 241 and one of the second level shifter 242 form a group and both receive the digital driving signal D. In other words, one of the first level shifters 241 and one of the second level shifter 242 are both connected to the same data latch unit 231 and receive the same digital driving signal D. Furthermore, the first level shifter 241 and the second level shifter 242 in the same group increase the voltage of the digital driving signal D received and then transmit the signal to the format conversion module 250 to be converted to another format.

The format conversion module 250 includes a plurality of first conversion units 251 and a plurality of second conversion units 252. The buffer amplifier module 260 preferably includes a plurality of buffer amplifiers 261,262 having voltage followers. As FIG. 2 shows, the first conversion unit 251 and the second conversion unit 252 receive the digital driving signal D from the first level shifter 241 and the second level shifter 242 respectively and then convert those digital driving signals D to analogue driving signals B. Afterward, the format conversion module 250 will transmit the analogue driving signals B to the sources of transistors of the pixel units 151 via the buffer amplifiers 261,262.

In the embodiment illustrated in FIG. 2, the first conversion unit 251 and the second conversion unit 252 are preferably analogue-to-digital converters composed of resistor ladder, but are not limited thereto; in different embodiments, the first conversion unit 251 and the second conversion unit 252 also include delta-sigma modulated converter, pulse-width modulated digital-to-analogue converter, or other types of converters.

Furthermore, in preferred embodiments, the liquid crystal molecules of the pixel units 151 cannot be maintained at a constant voltage. When a constant voltage is applied to the liquid crystal molecules over a period of time, the liquid crystal molecules will be damaged even after the voltages are removed. The damaged liquid crystal molecules can no longer rotate in order to form different grey levels and can create residual images on the display panel 150. Therefore, in order to avoid inflicting irreversible damages on the liquid crystal molecules, it is preferable to alter the voltages applied to the liquid crystal molecules periodically relative to the reference voltage V_{ref}.

For this reason, the first conversion unit 251 and the second conversion unit 252 will periodically change the voltage of the analogue driving signals B relative to the reference voltage V_{ref}. In the present embodiment, the voltage difference between the analogue driving signals B generated by the conversion units 251, 252 and a reference voltage V_{ref} remains constant. Furthermore, the analogue driving signals B generated by the first conversion unit 251 and the second conversion unit 252 are respectively greater than and smaller than the reference voltage. For instance, if the reference voltage V_{ref} is 8 volt, then the analogue driving signals B generated by the first conversion unit 251 and the second conversion unit 252 are respectively 10 volt and 6 volt. Conversely, if the analogue driving signal B generated by the first conversion unit 251 is 6 volt, then the analogue driving signal B generated by the second conversion unit 252 will be 10 volt. In this way, the variation of the voltages outputted by the first conversion unit 251 and the second conversion unit 252 can prevent the damage of liquid crystal molecules caused by constant voltage.

It can be seen from FIG. 2 and descriptions above that the first level shifter 241 and the second level shifter 242 in the same group accept digital driving signals D from the same data latch unit 231. Therefore, two of the pixel units 151 of the display panel 150 corresponding to the first level shifter 241 and the second level shifter 242 of the same group will receive substantially the same image data, but are not limited thereto; in different embodiments, the pixel driver 200 of the present invention can transmit the same digital driving signal D to more level shifters so that more pixel units 151 can receive the same image data. Furthermore, the pixel driver 200 of the present embodiment can use less data latch units to save the cost of producing the pixel driver 200 and reduce the overall size of the pixel driver 200.

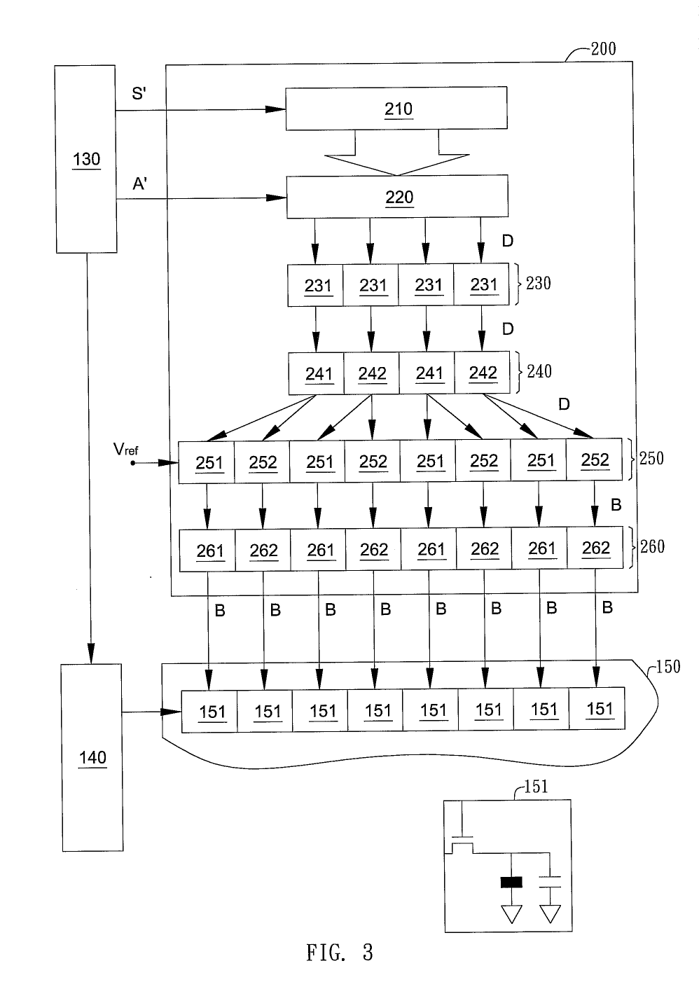

FIG. 3 illustrates another embodiment of the pixel driver 200 of the present invention. The difference between the pixel drivers 200 illustrated in FIG. 2 and FIG. 3 is the fact that the first conversion unit 251 and the second conversion unit 252 adjacent to each other are connected to the same level shifter to receive the same digital signal. In this way, the number of level shifters used and the cost of production of the pixel driver 200 as well as the size of the pixel driver 200 can be further reduced. Other than the number of electronic components used, the pixel drivers 200 illustrated in FIG. 2 and FIG. 3 have substantially the same operating principle and structure and therefore are not further elaborated here.

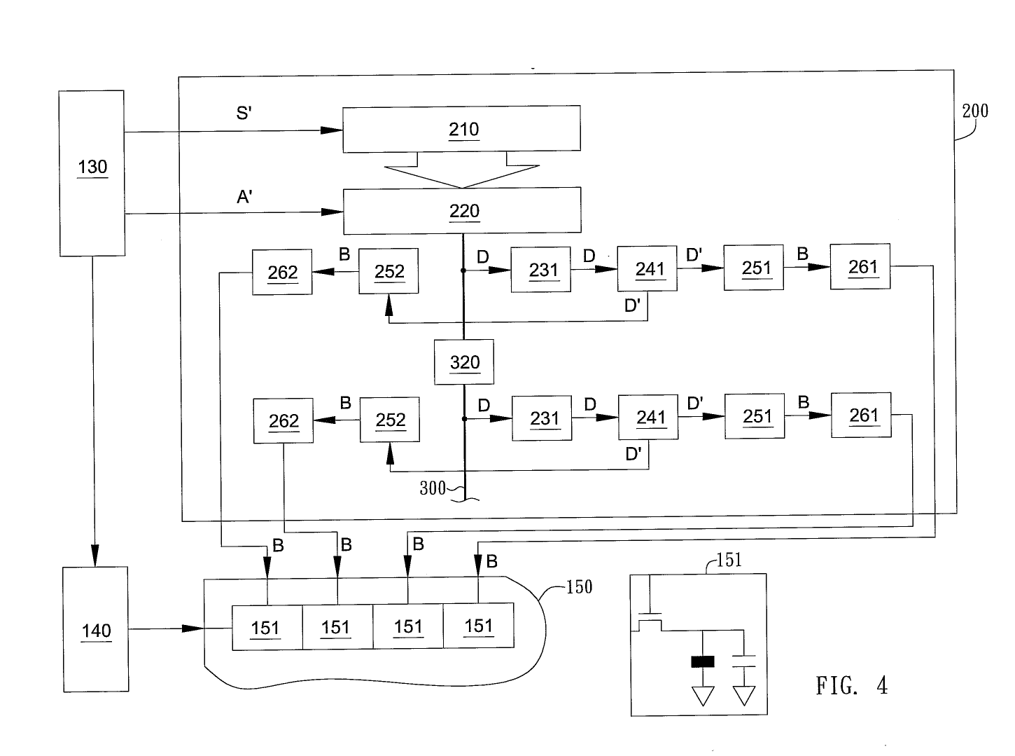

FIG. 4 is a variation of the pixel driver 200 illustrated in FIG. 3. In the present embodiment, the first conversion unit 251 and the second conversion unit 252 connected to the same level shifter are not adjacent to each other. The first conversion unit 251 is adjacent to the first level shifter 241 and receives the digital driving signal D′ from the first level shifter 241. On the other hand, the second conversion unit 252 is connected to the first level shifter 241 through a long conduction line in order to receive the same digital signal D′.

The image signal module 220 of the present embodiment transmits the digital driving signal D to the first level shifter 241 through a data bus 300 and the data latch unit 231, wherein the first level shifter 241 increases the voltage of the digital driving signal D. In addition, the conduction line crosses the data bus 300 for transmitting the high voltage digital driving signal D′ generated by the first level shifter 241 to the second conversion unit 252 to be converted to an analogue driving signal B. The voltage of the digital driving signal D transmitted by the data bus 300 is far lower than that of the high voltage digital driving signal D′ transmitted by the long conduction line. Therefore, the variation in the voltage of the high voltage digital driving signal D′ will create electric field and electric noises that can affect the voltage of the digital driving signal D. In this way, the data contained in the digital driving signal D transmitted through the data bus 300 may be distorted by the electronic noises mentioned above.

In order to reduce the influence of the high voltage digital driving signal D′ on the digital driving signal D, the pixel driver 200 of the present embodiment further includes a voltage booster 320 connected to the data bus 300, wherein the voltage booster 320 is used to increase the voltage of the digital driving signal D in the data bus 300 in order to reduce the influence of the high voltage digital driving signal D′ on the digital driving signal D. In this way, the image signal module 220 can transmit the digital driving signal D to the data latch unit 231 through the data bus 300 with the boost of the voltage booster 320 and no longer subject to the influence of the high voltage digital driving signal D′. In the embodiment illustrated in FIG. 4, the voltage booster 320 is preferably a simple voltage buffer used to provide the data bus 300 with direct voltages and reduce the voltage difference between the digital driving signal D and the high voltage digital driving signal D′, but is not limited thereto. In different embodiments, the voltage booster 320 also includes complementary metal-oxide-semiconductor (CMOS) inverter or voltage sources such as a fixed voltage source.

In the embodiments illustrated in FIG. 1 to FIG. 4, the pixel driver 200 of the present invention is preferably used in the liquid crystal planar display in order to drive the liquid crystal pixel units thereof, but is not limited thereto; in different embodiments, the pixel driver of the present invention with common electronic component structure for various applications can also be used in organic light emitting diode (OLED) display and other displays with display panels whose pixel units are to be driven separately.

The above is a detailed description of the particular embodiment of the invention which is not intended to limit the invention to the embodiment described. It is recognized that modifications within the scope of the invention will occur to a person skilled in the art. Such modifications and equivalents of the invention are intended for inclusion within the scope of this invention.

What is claimed is:

1. A pixel driver, comprising:
an image signal module for generating a digital signal;
a data latch module connected to the image signal module to receive and store the digital signal;
a level shifter module connected to the data latch module to receive the digital signal and increase the voltage of the digital signal; and
a format conversion module including at least a first conversion unit and a second conversion unit connected to the level shifter module to receive the digital signal, the first conversion unit and the second conversion unit generating a first analogue signal and a second analogue signal respectively based on the digital signal.

2. The pixel driver of claim 1, wherein the level shifter module includes a first level shifter and a second level shifter connected to the data latch module to receive the digital signal, the first level shifter increases the voltage of the digital signal received and then transmits the digital signal to the first conversion unit, the second level shifter increases the voltage of the digital signal received and then transmits the digital signal to the second conversion unit.

3. The pixel driver of claim 2, wherein one of the voltage of the digital signal generated by the first level shifter and the voltage of the digital signal generated by the second level shifter is greater than a reference voltage while the voltage of the other digital signal is smaller than the reference voltage.

4. The pixel driver of claim 1 further comprising a buffer amplifier module, wherein the buffer amplifier module includes at least a first buffer connected to the first conversion unit to receive the first analogue signal and a second buffer connected to the second conversion unit to receive the second analogue signal, the first buffer and the second buffer increase the voltage of the first analogue signal and the second analogue signal respectively.

5. The pixel driver of claim 1 further comprising a voltage booster connected to the image signal module, wherein the voltage booster increases the voltage of the digital signal generated by the image signal module.

6. A pixel driver, comprising:
an image signal module for generating a digital signal;
a data latch module connected to the image signal module to receive and store the digital signal;
a level shifter module connected to the data latch module to receive the digital signal and increase the voltage of the digital signal; and
a format conversion module including at least two conversion units connected to the level shifter module, wherein the conversion units generate analogue signals based on the digital signal.

7. The pixel driver of claim 6, wherein the level shifter module includes two level shifters connected to two conversion units respectively, the data latch module transmits the digital signal to the conversion units, the level shifters increase the voltage of the digital signal received and then transmit the digital signal to the corresponding conversion units.

8. The pixel driver of claim 6, wherein the level shifter module includes a level shifter connected to the conversion units, the level shifter receives the digital signal from the data latch module, increases the voltage of the digital signal received, and then transmits the digital signal to the conversion units.
